(19) United States
(12) Patent Application Publication
(10) Pub. No.: US 2019/0032551 A1
(43) Pub. Date: Jan. 31, 2019

(54) IMPROVED FUEL SYSTEM FOR DIESEL TYPE ENGINES USING CARBONACEOUS AQUEOUS SLURRY FUELS

(71) Applicant: COMMONWEALTH SCIENTIFIC AND INDUSTRIAL RESEARCH ORGANISATION, Acton, ACT (AU)

(72) Inventor: Louis James WIBBERLEY, Garden Suburb (AU)

(21) Appl. No.: 16/069,484

(22) PCT Filed: Jan. 10, 2017
(86) PCT No.: PCT/AU2017/050016

§ 371 Date: Jul. 11, 2018

(30) Foreign Application Priority Data
Jan. 13, 2016 (AU) 2016900094

(51) Int. Cl. F02B 45/10; F02D 19/04; F02M 43/04; F02M 55/00; F02M 57/02; F02M 59/46; F02M 61/18; F02M 67/12

(52) U.S. Cl. CPC F02B 45/10; F02D 19/04; F02M 43/04; F02M 67/12; F02M 57/02; F02M 59/46; F02M 61/18; F02M 55/00

(57) ABSTRACT

The present invention provides an improved fuel injection system and related method for controlling fuel heating and circulation in diesel type engines configured to use carbonaceous aqueous slurry fuels. The fuel injection system comprises: at least one fuel injector including an injector nozzle through which fuel is atomised and a fuel injector pump for pressurising fuel for supply to the injector nozzle; and a controlled bleed valve fluidly connected to each fuel injector and positioned to allow a controlled amount of carbonaceous aqueous slurry fuel to flow from the fuel injector.

### CROSS REFERENCE

The present application claims priority from Australian Provisional Patent Application No. 2016900094 filed on 13 Jan. 2016 the contents of which should be understood to be incorporated into this specification by this reference.

### TECHNICAL FIELD

The present invention generally relates to a fuel system for a diesel type engine using carbonaceous aqueous slurries. The invention is particularly applicable to a controlled bleed system and flushing system for an injector arrangement of a diesel type engine using carbonaceous aqueous slurries and it will be convenient to hereinafter disclose the invention in relation to that exemplary application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Current injection technology for conventional diesel and heavy fuel oil in diesel type engines employs pressure atomisation of relatively low viscosity fuel. For heavy fuel oils the fuel viscosity is controlled to 5 to 20 mPa·s by heating (up to 165° C.) before it enters the engine high pressure injection pumps. Low pressure fuel is provided at relatively constant pressure to the fuel system to provide a steady circulation and bleed of fuel oil to occur back to the hot service tank via a pressure relief valve and spring loaded valves in the injectors which snap open once the pressure from each injection event decreases to below that of the pressure from the low pressure delivery pump. This circulation maintains the fuel system at elevated temperature, assists the removal of air, and reduces the time for fuel switching.

An emerging technology is the use carbonaceous aqueous slurry fuels to replace heavy fuel oil for diesel type engines, for example as taught in International Patent Publication No. WO2015048843, the contents of which should be understood to be incorporated into this specification by this reference. Carbonaceous aqueous slurry fuels typically comprise an aqueous colloidal suspension of finely ground carbonaceous particles. The properties of the slurry fuels are therefore significantly different to diesel and fuel oils, in particular having a much higher viscosity and a tendency to destabilise and settle to form sludge, and can dry out in injector nozzles if an engine is stopped with slurry fuel in the system.

The production, transportation, storage and use of these fuels can cause a number of technical problems which have discouraged commercialisation. One significant problem is the prevention of the carbonaceous particles in the slurry settling in tanks and fuel lines, and blocking smaller orifices of the fuel injection equipment—both during engine operation and when the engines has stopped. Current art to avoid this problem has been to adopt the heavy fuel oil system of constantly circulating preheated fuel around the fuel system under a relatively constant fuel delivery pressure using a spring loaded pressure relief valve on a fuel circulation main. This allows the fuel system to bleed fuel from the high pressure circuit of the fuel injector via the pressure relief valve between injection events. However, a pressure relief valve is prone to damage and accelerated wear with slurry fuels. Moreover, the use of a preheated service tank requires a relatively large volume of fuel (say 8 to 24 hours consumption) be maintained at the injection temperature. This is problematic for aqueous slurry fuels which are prone to settling and destabilisation with extended high temperature handling. Agglomeration is also particularly deleterious to atomisation of aqueous slurries, leading to increased ignition delay and incomplete combustion—all of which can contribute to piston ring damage and severe reduction in engine longevity, plus reduce combustion efficiency.

While prior art can address this issue to some extent through the use of variable flow delivery pumps to reduce the circulating flow, this is likely to cause other issues because the fuel delivery pressure may be insufficient to optimally actuate the fuel injector pump, and more particularly plunger type fuel injector pumps that utilise fuel delivery pressure to retract the high pressure (injection) fuel injector pump plunger.

An additional problem with current art is the inability to perform complete and rapid flushing of the fuel system after the service tank without extended operation of the engine with the flushing fluid.

It would therefore be desirable to provide a fuel system, particularly a fuel injection system for a diesel type engine configured to use carbonaceous aqueous slurry fuels that reduce the degradation, destabilisation and agglomeration of carbonaceous aqueous slurry fuels in fuel systems. It would also be preferable to provide a more efficient and controlled flushing of the fuel system after the service tank.

### SUMMARY OF THE INVENTION

The present invention provides an improved fuel injection system and related method for controlling fuel heating and circulation in diesel type engines using carbonaceous aqueous slurry fuels that includes carbonaceous particles suspended in an aqueous medium such as those formed from coal, chars, carbon blacks and bitumen. Embodiments of the present invention can be configured to use a carbonaceous aqueous slurry fuel characterised as a type of micronized refined carbon fuel (MRC).

A first aspect of the present invention provides a fuel injection system of a diesel type engine configured to use carbonaceous aqueous slurry fuels, the fuel injection system comprising: at least one fuel injector including an injector nozzle through which fuel is atomised and a fuel injector pump for pressurising fuel for supply to the injector nozzle; and a controlled bleed valve fluidly connected to each fuel injector and positioned to allow a controlled amount of carbonaceous aqueous slurry fuel to flow from the fuel injector.

The use of controlled bleed valves on each injector of the fuel injection system provides a regulated circulating flow carbonaceous aqueous slurry fuel through the fuel injector system and also provides for controlled timing of a bleed flow of carbonaceous aqueous slurry fuel from each injector. The present invention therefore assists in the reduction of degradation, destabilisation and agglomeration of carbonaceous aqueous slurry fuels by controlling both bleed and circulation rate of the carbonaceous aqueous slurry fuel through the fuel system, and more particularly the fuel injection system of the engine.

The use of a controlled bleed valve replaces the need to use pressure relief valves, and thereby reduces standing time of any fuel in the injector if contamination by seal oil in the system, and reduces the time the fuel spends at elevated temperature. The arrangement can also increase the service life of the injector bleed valves and can assist in optimising engine efficiency through the reduction of clogging by carbonaceous particles within the fuel injection system. The use of controlled bleed values also allows for quicker and controlled flushing of the fuel system after the service tank.

The use of a controlled bleed valve can also advantageously eliminate the need for a traditional separate preheated circulation main for the fuel. In contrast to heavy fuel oil, carbonaceous aqueous slurry fuel can be injected and burnt well without the need for viscosity control using a preheat. This reduces the need to ensure accurate temperature control under all conditions (for example during fuel changeover, where the separate slurry fuel system may be cooler than preferred).

It should be appreciated that the fuel injection system and the fuel recirculation system of the present invention is suitable for use in diesel type compression ignition engines.

It should also be understood that diesel type engine encompasses any engine manufactured, constructed or modified to operate using a fuel including carbonaceous particles suspended in an aqueous medium. Suitable engines include conventional compression ignition or diesel type engines, dual fuel engines using direct injection of the carbonaceous fuel, or an engine improved, modified or otherwise derived from conventional compression ignition or diesel type engines to operate using a fuel including carbonaceous particles suspended in an aqueous medium. One example is a direct injection carbon engine (DICE)—a diesel type engine which has been modified to enable combustion of water-based slurry of micronised refined carbon fuel (MRC).

The present invention is suitable for use in a variety of fuel injection systems. By way of example, the present invention is suitable for use in a conventional injection arrangement whereby a fuel pumping element comprising a plunger is housed within a pump chamber. In these systems, the pump chamber is in communication with an injector nozzle via a fuel duct or fuel conduit connecting the nozzle to the pump chamber. The injector nozzle typically includes an injector valve biased to a normally closed position to regulate the injection of fuel into the combustion chamber. In this arrangement, downward movement of the plunger reduces the volume of the pump chamber causing an increase in pressure within the volume of fuel occupying the pump chamber and the fuel duct. This pressurises fuel for supply to the injector nozzle. This pressure increase overcomes the bias in the normally closed injector valve which moves to an open position in which fuel is permitted to spray from the injector nozzle into the combustion chamber. The release of fuel into the combustion chamber reduces pressure upstream of the injector nozzle causing the injector nozzle valve to return to its normally closed position whereupon spray through the injector nozzle is terminated. The pressurised fuel flow generated by the plunger travels away from the plunger and toward the injector nozzle via an injection path which is therefore defined by the collective volumes of the pump chamber and the fuel duct.

As noted above, the present invention is suitable for use with existing fuel injection arrangements which utilise a plunger-type fuel pumping element and a pressure-actuated injector nozzle. However it will be appreciated that these are merely some examples of a fuel pumping element and injector nozzle with which the present invention can be used. A variety of alternative fuel pumping systems and injector nozzles are suitable for use with the present invention. For example, the pump chamber and pumping element of the present invention may comprise any type of appropriate flow generating device depending on the required injection pressure for example a moving cavity pump, or a positive displacement pump such as a diaphragm pump. In embodiments of the invention where the fuel pumping element comprises a piston or plunger-type pumping element, the piston/plunger can be operated by a variety of actuation systems for example a cam arrangement, hydraulic arrangement or by an electronic solenoid system. Similarly, the injector nozzle of the present invention can be a conventional type injector nozzle (i.e. actuated to its open position by increasing pressure within the injection path) or, alternatively, could be selectively actuated by a separate system (for example a hydraulic or electronic system) to provide increased control over the injection events into the combustion chamber which, in some engine systems, are precisely timed to achieve increased combustion efficiency.

The carbonaceous aqueous slurry fuel used in the diesel type engine of the present invention comprises carbonaceous particles suspended in an aqueous medium. This fuel typically comprises an aqueous colloidal suspension of finely ground carbonaceous particles. The suspension can have a paste consistency. Furthermore, the carbonaceous particles are preferably hydrophobic as it improves the dispersion of the particles within the medium. One suitable example is taught in International Patent Publication No. WO2015048843A1, the contents of which should be understood to be incorporated into this specification by this reference.

The controlled bleed valve can have any suitable configuration. In preferred embodiments, the controlled bleed valve comprises at least one of an electronically controlled bleed valve or a hydraulically controlled bleed valve. In some embodiments, the controlled bleed valve comprises a Moog brand electronically controlled valve/actuator, which is preferably adapted for use with a carbonaceous aqueous slurry fuel, for example modification of valve seat material or the like.

The controlled bleed valve is preferably be selected to provide fast opening and closing to enable full opening and closing cycles during the period between the end of one injection event and the beginning of another, and more preferably during the period between refilling of the fuel pump and the beginning of the next injection event. For example, with an engine operating at 120 revolutions per minute, this period would be around 200 to 400 ms long (depending on whether it includes the refill time), and the opening and closing duration of the valve would ideally be around 20 ms. It should be appreciated that faster engine speeds would require proportionally quicker opening valves.

As noted above, the controlled bleed valve is operated to circulate the carbonaceous aqueous slurry fuel through the injector to reduce degradation, destabilisation and agglomeration of the carbonaceous aqueous slurry fuel. The bleed valve is preferably operated to allow flow from the fuel injector after the fuel injection pump draws fuel into the injector and before the fuel injector injects fuel through the injector nozzle. This allows the injector to operate normally to draw the requisite amount of fuel into the injector and expel/atomise that fuel through the injector nozzle. The bleed flow is preferably controlled by the duty of the bleed valve for a given fuel delivery pressure.

The controlled bleed valve can be fluidly connected to the injector at any suitable location. The controlled bleed valve is preferably fluidly connected by the injector around or between the fuel injector pump and the injector nozzle. This enables the system to be used for conventional pump-line-nozzle injection systems.

In some embodiments, the injector nozzle includes a flow valve for controlling flow through the injector nozzle and the controlled bleed valve is fluidly connected to the injector at or around said flow valve. The flow valve typically includes a valve seat, and the controlled bleed valve is therefore more preferably fluidly connected to the injector at or around the valve seat of the flow valve. Fluidly connecting the controlled bleed valve to the cut off valve seat advantageously eliminates settling in any dead volume proximate the valve seat and maximises the efficiency (completeness) of any flushing action. It should be appreciated that the flow valve can comprise any suitable pressure actuated valve. In some embodiments, the flow valve comprises a needle valve.

In other embodiments, the controlled bleed valve is fluidly connected to the fuel injector pump. In particular embodiments, the fuel injector pump comprises a plunger pump including a cylinder and driven plunger for pumping fuel to the injector nozzle and the controlled bleed valve is fluidly connected to a pump volume in the cylinder between the plunger and a fuel inlet of the plunger pump. It is envisaged that this arrangement would be advantageously used for injectors with smaller cross sections by moving the position of the fluid connection between the injector and the fuel injector relative to the injector nozzle closer to the fuel injector pump.

It should be appreciated that the bleed flowrate is dependent upon rheology of the carbonaceous aqueous slurry fuel and may vary between 1% and 100% of the full load flowrate flowing through the injector nozzle depending on engine load and whether flushing is required. In some embodiments, the bleed flowrate is between 1 to 20% of the full load flowrate, preferably between 1 to 5%. In other embodiments the bleed flowrate is from 3 to 15% of the full load flowrate, preferably from 3 to 10%, and in some embodiments about 5% of the full load flowrate. For example, a bleed flowrate comprising 1% of the full load flowrate would be suitable for a carbonaceous aqueous slurry fuel having good rheology characteristics in which particle settling and sludge formation is minimal. The bleed flow rate would be higher where fuel is prone to sludge formation.

The duty cycle of the bleed valve is preferably adjusted according to properties of the fuel. In some embodiments, the duty cycle of the bleed valve is 10 to 20% of the time open for poor rheology fuel, but not opened during injection, i.e. synced. The conduit or pipe size of the bleed valve is preferably at least 5 times greater than largest carbonaceous particle in the carbonaceous aqueous slurry fuel to minimise erosion/wear. In some embodiments, the duty cycle may comprise a cyclical cycle between bleed and flushing cycles. In embodiments, this cycle may comprise an on-off square wave type cycle use to clear any debris or particle build up, particularly where the fuel is prone to sludge formation. In some embodiments, the system includes at least one sensor or testing system which is operable to determine coal slurry properties and correlate properties with optimal duty cycle settings.

In some embodiments, the opening and closing duty of the bleed valve can also be used to control the amount of fuel injected into the engine. For example, for hydraulically actuated pumps, the bleed valve can be used to control how far the driven plunger moves for example in a down-stroke used to pump fuel to the injector nozzle.

The injector nozzle can comprise any suitable fuel atomiser nozzle that can be used with carbonaceous aqueous slurry fuel. An example of one suitable injector nozzle, forming part of a blast atomiser type injector is taught in International Patent Publications WO2013142921A1 and WO2015048843A1 by the same applicant, the contents of which should be understood to be incorporated into this specification by this reference.

The fuel injector system of the present invention can include a number of fluidly connected units within the overall system. In some embodiments, the fuel injector system further includes a fuel delivery pump for pumping fuel to the fuel injector. The fuel delivery pump is typically in fluid communication with an inlet of each injector.

Each controlled bleed valve is preferably fluidly connected to a fuel recycle system. The fuel recycle stream is preferably fluidly connected between the outlet of the controlled bleed valve and an inlet of the fuel delivery pump. Thus, during normal operation the bleed flow from the controlled bleed valves is redirected to the inlet of fuel delivery pump(s) to avoid contaminating the service or day tank(s) with hot degraded/contaminated fuel, and reduce the time before hot degraded fuel is injected into the engine.

During normal operation of the engine, the pressure in the fuel injector system and/or the recycle stream is typically between 10 to 50 bar, more preferably between 20 to 30 bar. The temperature of the fuel in the recycle stream is typically between 50 to 150° C., preferably between 70 and 130° C.

Some embodiments of the fuel injector system can further including a fuel circulation main, wherein the return from the fuel circulation main is fluidly connected to the inlet of the fuel delivery pump. Each controlled bleed valve is preferably fluidly connected to a fuel recycle system. The fuel recycle stream, in this embodiment including a fuel circulation main, is connected to the inlet of the fuel delivery pump and not the service tank. This eliminates mixing hot fuel with the cooler fuel in the service tank and reduces the tendency for destabilisation.

The fuel recycle stream can comprise a circuit with a number of alternative connections. As noted above, the fuel recycle stream is preferably connected to the fuel delivery pump in order to directly recycle the bleed fuel to the injectors. However, it can also be preferable to divert or selectively remove fluid from the recycle, for example contaminated fuel, degraded fuel, flushing fluid or the like so that that fluid is not recycled back into the fuel injectors. Therefore, in some embodiments the fuel recycle stream includes a connection to a waste stream into which flow can be selectively diverted to remove fluid from the recycle stream. Any suitable fluid connection could be used. In some embodiments, the waste stream is fluidly connected to the recycle stream using a controlled three way valve. The fuel system is provided with valve to direct bleed flow to a waste tank or flushing fluid recovery system during system flushing or periods of abnormal operation.

In some embodiments, the fuel injector system further includes a service tank into which fresh carbonaceous aqueous slurry fuel is feed, the service tank being fluidly connected to an inlet of the fuel delivery pump. The service tank is preferably operated at a lower temperature the fuel injection system. This lower service temperature of the service tank further reduces slurry destabilisation. In embodiments, a service tank temperature of between 20 and 50° C., more preferably between 25 to 40° C. will be suitable for most fuels. It is noted that this is around half the temperature currently used in comparative conventional diesel type engines. A control valve is preferably fluidly connected between to the outlet of the service tank, the outlet of a flushing fluid line and the inlet to the fuel delivery pump. The control valve can be used to interrupt the flow from the service tank and to enable pumping of flushing fluid into the engine fuel system. This valve could advantageously be a three-way valve or two separate valves.

In some embodiments, the fuel injector system further includes fuel preconditioning system fluidly connected to the inlet of the injector system, the fuel preconditioning system including a fuel preheater for heating the fuel to a service temperature. The preconditioning system may also include a fuel strainer with a screen to remove extraneous coarse material such as flakes of rust from bunker tanks. The fuel preheater is preferably located before the fuel strainer to reduce the fuel viscosity before screening through the strainer. Fuel preheat is preferably varied according to the properties of the fuel and the return bleed flow to maximise the temperature of the injected fuel whilst minimising the average time that fuel is at elevated temperature. The preheater typically heats the fuel flowing therethrough to a temperature of between 50 to 150° C., preferably between 70 to 130° C. The acceptable ti me-temperature profile will be different for different fuels.

The present invention differs considerably from current art by allowing close control of fuel delivery conditions to the engine to achieve best combustion and thermal efficiency (maximum fuel preheat) whilst substantially reducing the time-temperature at conditions that cause fuel destabilisation.

In some embodiments, the fuel injector system further includes a control valve fluidly connected between the fuel preconditioning system and a waste tank or a fluid recovery system. This control valve can be selectively operated during system flushing or periods of abnormal operation to direct fluid from fuel preconditioning system to a waste tank or a fluid recovery system. Use of this control valve advantageously reduces the time for flushing. Any suitable value configuration could be used. In some embodiments, this control valve comprises a three-way valve.

The fuel injection system of the present invention can be used in a number of applications. In some embodiments, the fuel injection system is used in a stationary power generation engine. In these embodiments, the engine comprises a large engine typically fixed in place within a building or other enclosure which primarily used to generate electricity. In other embodiments, the fuel injection system is used in a transportation engine, typically to propel a vessel. Examples of transportation engines include use of an engine to power and propel locomotives, ocean going vessels such as ships, ocean liners, barges or the like. However, it should be appreciated that other vehicle engines such as trucks or the like could utilise suitable sized and powered engines using the fuel injection system of the present invention.

A second aspect of the present invention provides a fuel recirculation system of a diesel type engine configured to use carbonaceous aqueous slurry fuels, the diesel type engine including a fuel injection system comprising at least one fuel injector that comprises an injector nozzle through which fuel is atomised and a fuel injector pump for pressurising fuel for supply to the injector nozzle. The fuel recirculation system includes at least one controlled bleed valve fluidly connected to each fuel injector that is positioned to allow a controlled amount of carbonaceous aqueous slurry fuel to flow from the respective injector.

It should be appreciated that the fuel recirculation system of this second aspect of the present invention preferably includes including a fuel injection system according to the first aspect of the present invention. It should be understood that all the features previously discussed in relation to the first aspect of the present invention can equally be incorporated into this second aspect of the present invention.

A third aspect of the present invention provides a diesel type engine configured to use carbonaceous aqueous slurry fuels comprising a fuel injection system comprising at least one fuel injector, each injector including:

an injector nozzle through which fuel is atomised and a fuel injector pump for pressurising fuel for supply to the injector nozzle; and

a controlled bleed valve fluidly connected to each fuel injector and positioned to allow a controlled amount of carbonaceous aqueous slurry fuel to flow from the respective injector.

It should be appreciated that the diesel type engine of this third aspect of the present invention preferably includes a fuel injection system according to the first aspect of the present invention. It should be understood that all the features previously discussed in relation to the first aspect of the present invention can equally be incorporated into this third aspect of the present invention.

It should also be appreciated that the diesel type engine of this third aspect of the present invention can comprise any engine capable of running using a carbonaceous aqueous slurry fuel, such as a direct-injection, compression ignition or diesel type engine. In preferred forms, the engine comprises a modified diesel type engine, such as a diesel type engine having a blast injector/blast atomiser type injector.

A fourth aspect of the present invention provides a method for controlling fuel heating and circulation in a diesel type engine using of carbonaceous aqueous slurry fuels, the diesel type engine including a fuel injection system according to the first aspect of the present invention, the fuel injector operating to inject fuel into a combustion chamber of the engine, the method including the steps of: operating the bleed valve to allow flow from the fuel injector between fuel injection events into the combustion chamber.

The controlled bleed valve is preferably operated to allow flow from the fuel injector after the fuel injection pump draws fuel into the injector and before the fuel injector injects fuel through the injector nozzle. In embodiments, the fuel injector pump comprises a plunger pump including a cylinder and driven plunger for pumping fuel to the injector nozzle and the fuel injection pump draws fuel into the injector through retraction of the plunger.

The bleed flow is preferably controlled by the duty of the bleed valve for a given fuel delivery pressure. In embodiments, each controlled bleed valve is fluidly connected to a fuel recycle system. Here, pressure drop in the recycle stream is preferably controlled by a pressure drop in internal flow channels in the injector before and after the electronically controlled bleed valve. This pressure drop is controlled to reduce the shear intensity experienced by the bleed flow passing over throttling valves.

During normal engine operation, the fuel recycle stream preferably directs fuel from the bleed valves to the inlet of the fuel delivery pump. This bleed and recycle flow directly recycles the bleed flow to the fuel injection system thereby avoiding contaminating the service or day tank(s) with hot degraded/contaminated fuel, and reducing the time before hot degraded fuel is injected into the engine.

The present invention also enables complete and rapid flushing of the fuel system after the service tank without extended operation of the engine with the flushing fluid. A flushing fluid for carbonaceous aqueous slurries is preferably a substantially incombustible fluid such as water or a suitable detergent mixture and so even with a duel fuel injection system, with a separate fuel system using conventional oil fuels, excessive use of flushing fluid/extended duration for flushing are likely to be undesirable due to likely poor combustion of diluted slurry fuel.

A fifth aspect of the present invention provides a method of flushing the injector system of a diesel type engine using of carbonaceous aqueous slurry fuels, the diesel type engine including a fuel injection system according to the first aspect of the present invention, the method including the steps of: operating the bleed valve to allow continuous flow from the fuel injector.

In embodiments, each controlled bleed valve is fluidly connected to a fuel recycle system. The recycle stream is preferably configured to direct the flushing fluid flow from the bleed valves to a waste stream.

In some embodiments, the fuel injector is operated for at least one cycle, preferably a plurality of cycles at the end of the fuel system flushing operation. This allows flushing fluid to flow around all passages in the injector to ensure complete flushing of each injector. In this respect, passages in each injector are flushed below the flow valve of the injector nozzle including the valve seat of the flow valve and the surfaces of the injector nozzles. This flushing cycle can be operated on a regular basis, for example every 20 revolutions of the engine in order to reduce and/or prevent delirious build-up of fouling particles in the fuel injection system.

### BRIEF DESCRIPTION OF THE DRAWINGS

The present invention will now be described with reference to the figures of the accompanying drawings, which illustrate particular preferred embodiments of the present invention, wherein:

FIG. 1 provides a schematic of a fuel injection and recycle system according to one embodiment of the present invention providing about 5% return flow to a fuel delivery pump fluidly connected to an inlet of the engine containing at least one controlled bleed valve as illustrated in FIGS. 2 to 5.

FIG. 1A provides a cross-section of the diesel-type engine from the fuel injection system shown in FIG. 1 illustrating the location of the injector in that engine.

FIG. 2 provides a schematic drawing of one embodiment of a controlled bleed system according to the present invention configured for a hydraulically geared unit pump-injector with bleed flow taken from around the cut off or needle valve seat.

FIG. 3 provides a schematic drawing of one embodiment of a controlled bleed system according to the present invention configured for an ungeared unit pump-injector with bleed flow taken from around the cut off or needle valve seat.

FIG. 4 provides a schematic drawing of one embodiment of a controlled bleed system according to the present invention configured for a hydraulically geared unit pump-injector with bleed flow taken from the pump volume.

FIG. 5 provides a schematic drawing of one embodiment of a controlled bleed system according to the present invention configured for an ungeared unit pump-injector with bleed flow taken from the pump volume.

### DETAILED DESCRIPTION

The present invention comprises a fuel injection system and related method for controlling fuel heating and circulation in diesel type engines using carbonaceous aqueous slurry fuels.

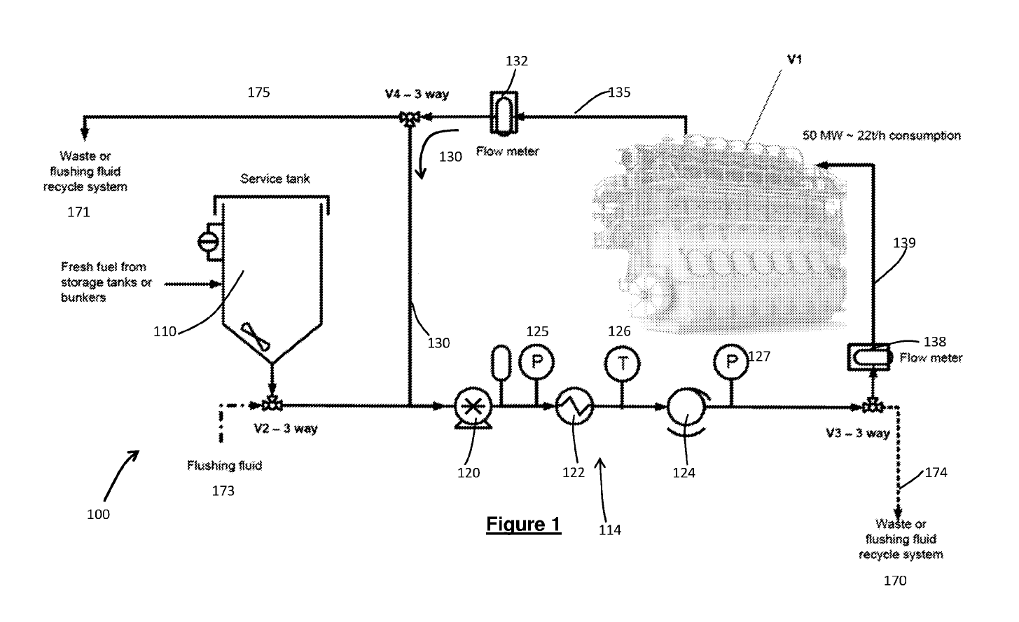

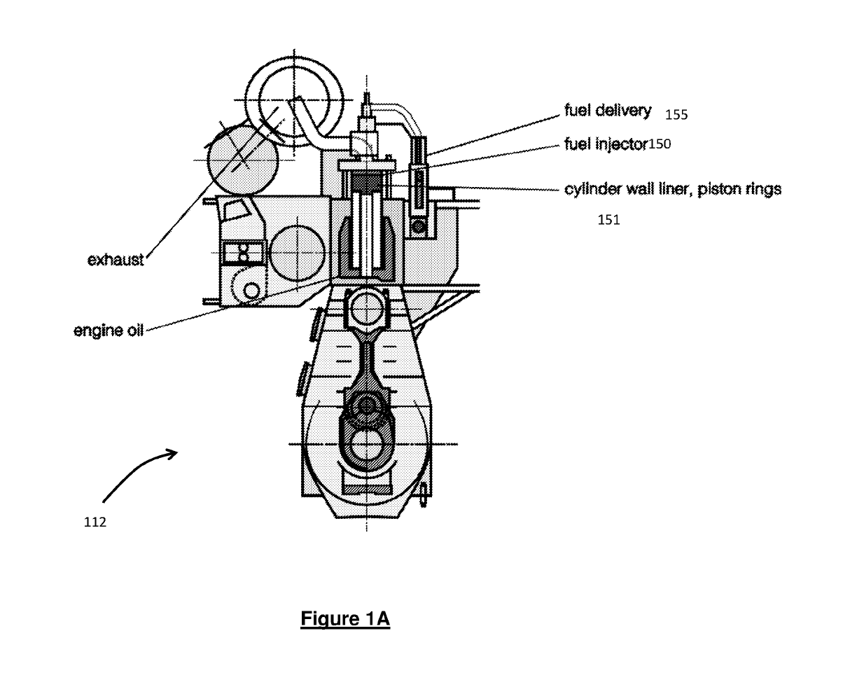

The fuel injection system (FIG. 1) of the present invention utilises electronically controlled bleed valves (V1 FIG. 1) on each injector 150 (see FIGS. 2 to 5) that can be used to regulate the circulating flow and timing of bleed flow from each injector. In contrast to heavy fuel oil, carbonaceous aqueous slurry fuels can be injected and burn well without the need for viscosity control by preheat thereby eliminating or reducing the need to ensure accurate temperature control under all conditions (e.g. during fuel change over where the separate slurry fuel system may be cooler than preferred).

Without wishing to be limited to any one theory, the inventors have discovered that carbonaceous aqueous slurry fuels generally behave adversely to high shear or cavitation conditions such as experienced through pressure relief valves and throttling valves. Problems include a particle decrepitation and particle agglomeration. These effects are increase significantly with increased temperature. Agglomeration is further increased by contamination of the circulating slurry from the use of seal oil to protect fuel injector pump plungers and valve spindles. The Inventors have found that this contaminated fuel need to be used as soon as possible to reduce the tendency for agglomeration (oil causes coal in coal-water slurries and bitumen in bitumen-water slurries to agglomerate). The current art of returning the circulating flow to the service tank will therefore lead to a build-up of destabilised slurry fuel which is likely to lead to blocking of fuel strainers and solid dropout in fuel lines (particularly at fittings and sudden increase in flow area).

It should be appreciated carbonaceous aqueous slurry fuels comprise an aqueous slurry or suspension type fuel that includes carbonaceous particles suspended in an aqueous medium. The carbonaceous particles may be sourced from any suitable carbonaceous source including, but not limited to a variety of coal, chars, bitumen, charcoal, wood, various hydrocarbons, and organic matter whether biological in nature or organic compounds etc. Preferably, the carbonaceous material is coal. Any type of coal may be used, for example anthracite, bituminous coal, or a brown or lignitic coal may be used. This is particularly advantageous as coal is readily available as a carbonaceous source. It is preferred that the carbonaceous source has low ash content, preferably less than 2 wt %, more preferably less than 1 wt %, most preferably less than 0.5 wt %. An example of one suitable type of carbonaceous aqueous slurry fuels is taught in International Patent Publication No. WO2015048843A1, the contents of which again should be understood to be incorporated into this specification by this reference.

In the case where the carbonaceous particles are coal, it is preferred that the coal has undergone some form of pre-treatment. Pre-treatment may include removal of the bulk of the mineral ash contamination and in the case of the lower rank coals some form of densification and alteration of the surface properties to render the coal more hydrophobic to enable a fuel with a higher coal loading to be achieved. For example bituminous coal demineralisation can be achieved by selective agglomeration, flotation and cyclones. An example of one suitable injector nozzle, forming part of a blast atomiser type injector is taught in International Patent Publications WO2013142921A1 and WO2015048843A1 by the same applicant, the contents of which again should be understood to be incorporated into this specification by this reference.

Carbonaceous aqueous slurry fuels can be used to replace heavy fuel oil for diesel type engines, particularly for stationary electricity generation at greater than the 5 MW scale, and for large shipping. The fluid properties of coal water slurry fuels are significantly different to diesel and fuel oils, in particular the coal slurry have a much higher shear-thinning non-Newtonian viscosity, and both the coal particles and contaminant mineral particles are abrasive to low hardness steel, preventing the fuel from lubricating the fuel system. Coal water slurry fuels have been successfully demonstrated in adapted diesel type engines in a number of demonstration programs—provided hardened fuel system components were used, and the fuel had a sufficiently low viscosity.

Embodiments of the present invention can be configured to use a carbonaceous aqueous slurry fuel characterised as a type of micronized refined carbon fuel (MRC). Micronising involves fine milling a solid carbonaceous (carbon-containing) material to about 10 to 60 microns. Refining involves physically cleaning the carbonaceous material, so as to remove most of the mineral matter to produce a fuel with approximately 1 percent mineral content. The fine carbonaceous material and water are combined to produce an aqueous slurry/suspension containing 40 to 50% water.

It should be appreciated that the present invention is suitable for use in a directly injected combustion chamber of a compression ignition or diesel type engine. The particular engine may therefore comprise a conventional compression ignition or diesel type engine, or an engine improved, modified or otherwise derived from conventional compression ignition or diesel engines to operate using a fuel including carbonaceous particles suspended in an aqueous medium.

One example is a direct injection carbon engine (DICE)—which is one type of a diesel type engine 112, which has been modified to enable combustion of water-based slurry of micronised refined carbon fuel (MRC) as shown in FIGS. 1 and 1A.

FIG. 1 provides a schematic of the one embodiment of the fuel injection system 100 according to the present invention that provides during bleed flow from 1 to 20%, preferably 3 to 10%, more preferably about 5% return flow to a fuel delivery pump 120 fluidly connected to an inlet of the engine 112 containing at least one controlled bleed valve V1 as illustrated in FIGS. 2 to 5. However, it should be appreciated (as described below) that in flushing mode that return flow may be up to 100%. Similarly, the bleed flow may also be adjusted to maintain system temperature. The illustrated fuel injection system 100 comprises a fuel circulation circuit that supplies fresh fuel from a service tank 110 to diesel type engine 112. The service tank 110 is connected to the engine through preconditioning circuit 114 which includes a fuel delivery pump 120, preheater 122 and fuel strainer 124. Pressure and temperature of the fuel in that circuit 114 is monitored using appropriate pressure and temperature sensors 125, 126, 127. A bleed flow of fuel from the injectors 120 in the engine 112 (see FIGS. 2 to 5 for further detail of the injectors 120) is recycled in normal operation to the preconditioning circuit 114 via fuel recycle stream 130. Flow meter 132 monitors the flow of fluid from the engine 112 via the bleed stream 135. Flow meter 138 monitors the flow of fluid being fed into the engine 112 via feed stream 139.

As previously noted, the controlled bleed valve V1 is preferably be selected to provide fast opening and closing to enable full opening and closing cycles during the period between the end of one injection event and the beginning of another, and more preferably during the period between refilling of the fuel pump and the beginning of the next injection event. It should be appreciated that controlled bleed valve V1 can comprise any suitable bleed valve. A number of valve configurations would be suitable, including both inwards and outwards opening valves, which are either directly operated using a solenoid acting to pull open a spring loaded valve spindle, or indirectly using a small high speed servo hydraulic valve which controls hydraulic oil flow to either open or close the valve via a hydraulic piston attached to the slurry valve. A number of commercial actuation equipment are available, for example Moog brand actuation equipment, but in all cases the valve switching the slurry flow should be provided with hard valve surfaces such as tungsten carbide or ceramic inserts to resist abrasion and galling by the particles in the slurry, and have provision to protect any sliding valve spindles from slurry ingress. In embodiments, this can be advantageously provided by applying a high pressure sealing fluid to the valves spindle, in a similar manner to that provided to protect the other injector components in particular the pump plunger and cut off needle, and which would therefore be advantageously facilitated by incorporating the high speed slurry valve into the same unit injector assembly. In some embodiments, the controlled bleed valve V1 comprises a Moog brand electronically controlled valve/actuator, for example 72 series servo valves, which is preferably adapted for use with a carbonaceous aqueous slurry fuel as noted above.

Referring to FIG. 1, fresh fuel is supplied into the illustrated fuel injection system 100 via a service tank 110. The service tank 110 is typically a closed tank located proximate the engine 112 containing a reservoir of fuel for that engine 112. The service tank 112 is advantageously operated at a much lower temperature than that used for injection in the engine 112 which further reduces slurry destabilisation. The inventors consider that a service tank temperature of 25 to 40° C. will likely be suitable for most carbonaceous aqueous slurry fuels used in the engine 112. A valve V2 (FIG. 1) is provided to interrupt the flow from the service tank 110 and to enable pumping of flushing fluid 173 into the engine fuel system (as outlined below). This valve V2 could advantageously be a three-way valve or two separate valves.

The service tank 110 feeds fuel to the fuel delivery pump 120 of the fuel preconditioning circuit 114. The fuel delivery pump 120 can comprise any suitable pump including those known in the art for diesel engines, such as mechanical, hydraulic, inline, unit injectors or the like. The fuel preconditioning circuit 114 is used to condition the fuel to suitable properties (temperature, pressure, viscosity and the like) prior to being fed into the fuel injector system of the engine 112. As illustrated, the main fuel preheater 122 is located before fuel strainer 127 thereby allowing the strainer 127 to take advantage of the reduced viscosity of the preheated slurry. The fuel preheater 122 can comprise any suitable fuel preheating unit, including those known in the art for diesel engines which thermally heat the fuel to a selected temperature. Similarly, the fuel strainer 127 can comprise any suitable fuel filter or straining unit, including those known in the art for diesel engines. Fuel preheat should be varied according to the properties of the fuel and the return bleed flow to maximise the temperature of the injected fuel whilst minimising the average time that fuel is at elevated temperature. The preheater typically heats the fuel flowing therethrough to a temperature of between 50 to 150° C., preferably between 70 to 130° C. The acceptable time-temperature profile will be different for different fuels. The present invention differs considerably from current art by allowing close control of fuel delivery conditions to the engine to achieve best combustion and thermal efficiency (maximum fuel preheat) whilst substantially reducing the time-temperature at conditions that cause fuel destabilisation.

It should be appreciated that the components of the fuel preconditioning circuit 114 are well known in the art and can be selected from known components, for example as discussed in K. Nicol “The direct injection carbon engine”, IEA Clean Coal Centre report CCC/243, December 2014—https://www.usea.org/sites/default/files/122014_The %20direct %20injection %20 carbon %20engine_ccc243.pdf, the contents of which should be understood to be incorporated into this specification by this reference.

The preconditioning circuit 114 is connected to feed stream 139 via valve V3 (FIG. 1). Valve V3 can be used to divert fuel flow from the fuel preconditioning circuit 114 to waste stream 174 that connects to a waste tank or flushing fluid recovery system 170 during system flushing or periods of abnormal operation to advantageously reduce the time for flushing. Valve V3 could advantageously be a three-way valve.

The illustrated engine 112 (FIGS. 1 and 1A) can comprise any engine capable of running using a carbonaceous aqueous slurry fuel, such as a direct-injection, compression ignition or diesel type engine. In preferred forms, the engine comprises a modified diesel type engine, such as a diesel type engine having a blast injector. It can be advantageous to use a blast atomiser injector as it directly applies the kinetic energy intensity to atomise high solids content fuel that is highly viscous with a wide size distribution, containing both a high proportion of fine material as well as a larger top size. The direct application of kinetic energy from the blast fluid circumvents frictional energy losses within the fuel allowing more atomization energy to be used efficiently (i.e. to overcome surface tension effects.) The much lower fuel velocity and larger fuel passages minimize frictional losses handling the fuel as well as admit a larger maximum size of fuel particle than would otherwise be possible. An example of one suitable blast atomiser injector is taught in International Patent Publications WO2013142921A1 and WO2015048843A1 by the same applicant, the contents of which should be understood to be incorporated into this specification by this reference.

FIG. 1A provides a cross-sectional view of an example two-stroke DICE engine 112 that can incorporate the fuel injection system of the present invention. Examples of these engines are taught in Wibberley L J (2013) Coal base-load power using micronised refined coal (MRC). Energy Generation, pp 35-39 (January-March 2011) the contents of which should be understood to be incorporated into this specification by this reference. This engine is a diesel type engine modified to have a direct fuel injector 150 similar to those illustrated in FIGS. 2 to 5. As shown in FIG. 1A, the fuel injector 150, and more particularly the injector nozzle 152 is situated above the piston housing 151 and has a fluid connection to fuel injector pump 155.

FIGS. 2 to 5 illustrate four different embodiments of fuel injector 150 of the engine 112 including fluidly connected controlled bleed valves V1. It should be appreciated that whilst electronically controlled bleed valves V1 are used in the illustrated embodiments, other types of controlled bleed valves such as hydraulically controlled bleed valves could equally be used without departing from the spirit or scope of the invention.

In each of the illustrated embodiments in FIGS. 2 to 5, the illustrated fuel injector system 118 comprises a fuel injector 150 which has an injector nozzle 152 through which fuel is atomised and a fuel injector pump 154 for pressurising fuel for supply to the injector nozzle 152. The injector nozzle 152 includes a flow valve, typically a needle valve (not illustrated) for controlling flow through the injector nozzle 152. The flow valve typically includes a valve seat (not illustrated). The illustrated fuel injector pump 154 comprises a plunger pump including a cylinder and driven plunger 155 for pumping fuel to the injector nozzle 152.

In each of the illustrated embodiments in FIGS. 2 to 5, a controlled bleed valve V1 is then fluidly connected to each fuel injector 150 in a position which allows a controlled amount of carbonaceous aqueous slurry fuel to flow from the fuel injector 150 to the fluidly connected fuel recycle stream 130 (FIG. 1). The bleed valve V1 is operated to allow flow from the fuel injector 150 into the recycle stream 130 after the fuel injection pump 155 draws fuel into the injector 152 and before the fuel injector 150 injects fuel through the injector nozzle 152. This allows the injector 150 to operate normally to draw the requisite amount of fuel into the injector 150 and expel/atomise that fuel through the injector nozzle 152. The bleed flow is preferably controlled by the duty of the bleed valve V1 for a given fuel delivery pressure. During normal operation of the engine 112, the bleed flow is redirected via the recycle stream 130 to the inlet of the fuel low pressure delivery pump(s) 120 (FIG. 1) to avoid contaminating the service or day tank(s) with hot degraded/contaminated fuel and/or to reduce the time before hot degraded fuel is injected into the engine 112. The bleed return from the controlled bleed valve V1 to the fuel delivery pump 120 can be around 1 tph.

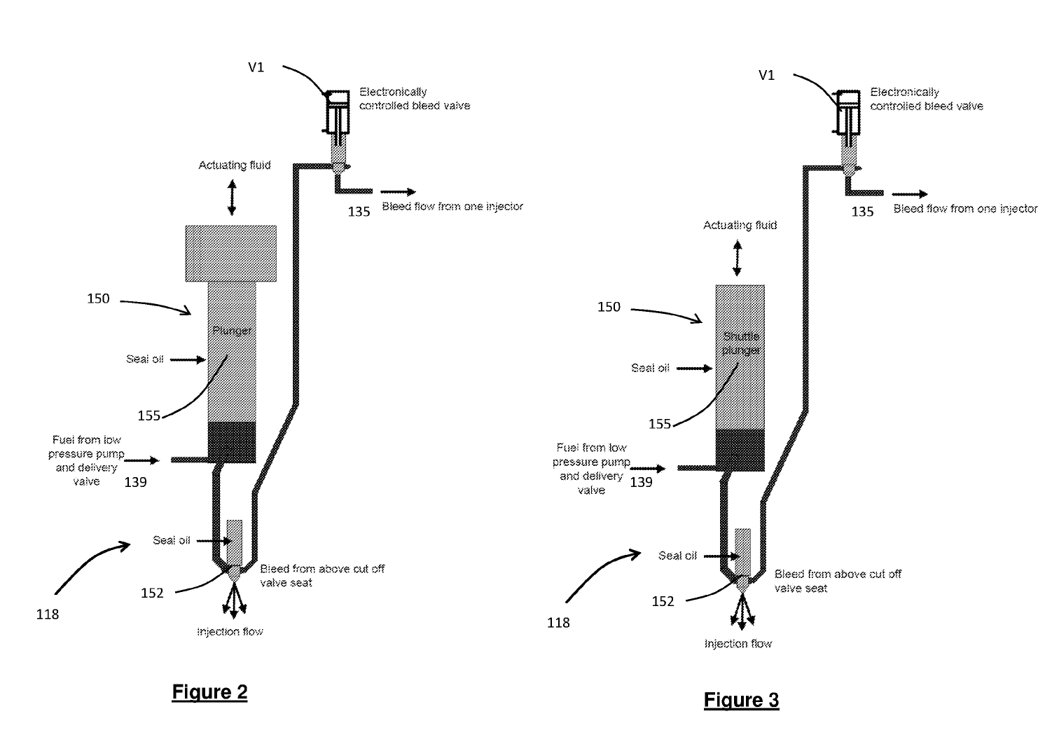

The controlled bleed valve can be fluidly connected to the injector at any suitable location. As shown in FIGS. 2 and 3, the controlled bleed valve V1 can be fluidly connected to the injector 150 at or around the valve seat of the flow valve of the injector nozzle 152. Fluidly connecting the controlled bleed valve V1 to the cut off valve seat advantageously eliminates settling in any dead volume proximate the valve seat and maximises the efficiency (completeness) of any flushing action. FIGS. 2 and 3 show schematics of this embodiment using geared and ungeared hydraulically actuated injectors 150. FIG. 2 shows an embodiment where the fuel injector pump 154 is a hydraulically geared unit pump-injector 150A and the bleed valve V1 is connected around the cut off or needle valve seat of the injector nozzle 152. FIG. 3 shows an embodiment where the fuel injector pump 154 is an ungeared unit pump-injector and the bleed valve V1 is connected around the cut off or needle valve seat of the injector nozzle 152. These preferred arrangements take the bleed flow from around the cut off valve seat (i.e. needle valve seat) to eliminate settling in this dead volume and to maximise the efficiency (completeness) of flushing.

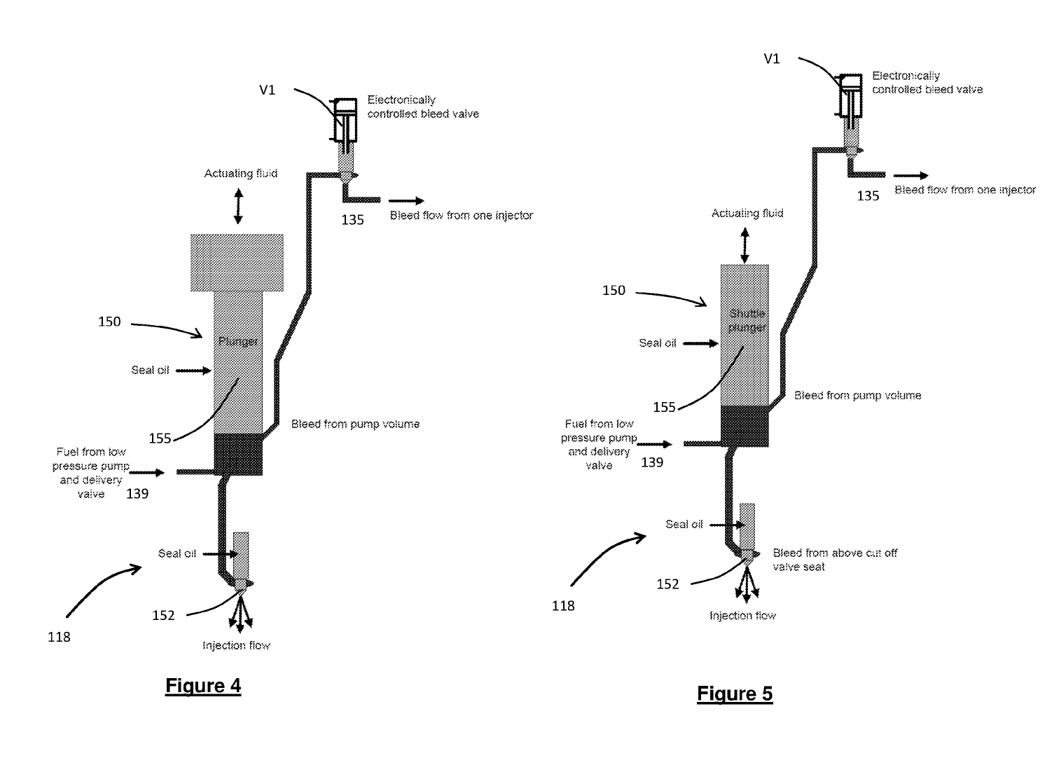

In other embodiments, the controlled bleed valve V1 is fluidly connected to the fuel injector pump 154 and therefore take the bleed flow for the recycle stream 130 from the pump volume of the fuel injector pump 154. FIG. 4 and show schematics of this embodiment using geared and ungeared hydraulically actuated injectors 150. FIG. 4 shows an embodiment where the fuel injector pump 154 is a hydraulically geared unit pump-injector 150A and the bleed valve V1 is connected to the pump volume of the fuel injector pump 154. FIG. 5 shows an embodiment where the fuel injector pump 154 is an ungeared unit pump-injector and the bleed valve V1 is connected to the pump volume of the fuel injector pump 154. It is envisaged that this arrangement would be advantageously used for injectors with smaller cross sections by raising the position of the bleed conduit.

The pressure drop of the bleed flow from the injector 150 is advantageously controlled by the pressure drop in in the conducting channels in the injector 150 both before and after the electronically controlled bleed valve V1 to reduce the shear intensity experienced by the bleed flow as compared to a similar flow passing over throttling valves.

A bleed flow of fuel from the injectors 120 in the engine 112 (see FIGS. 2 to 5 for further detail of the injectors 120) is recycled in normal operation to the preconditioning circuit 114 via fuel recycle stream 130. During flushing the fuel recycle stream 130 is connected to waste diversion stream 175 via operation of valve V4 (FIG. 1). Valve V4 can therefore be used to divert fuel flow from the fuel recycle stream 130 to a waste tank or flushing fluid recovery system 171 during system flushing or periods of abnormal operation to advantageously reduce the time for flushing. This valve V4 could advantageously be a 3-way valve.

During fuel system flushing the electronically controlled bleed valves V1 can be advantageously operated with an extended duty cycle, including continuously open, to provide rapid system flushing. To ensure complete flushing the injector can be advantageously operated for several cycles preferably at the end of the fuel system flushing period. This method will flush the injector passages below the cut of valve (i.e. needle valve) including the cut off valve seat and injector atomiser nozzles 152. During the flushing cycle, valves V2 is operated to feed flushing fluid 173 and valve V3 and/or V4 are operated to remove waste fluid from the fuel injection system 100 and the overall circuit. This allows the engine 112 and in particular the fuel injection system 100 to be regularly flushed and cleaned to remove any sludge or deposits in that system. Additionally, this provides the ability to flush the fuel system and comprising fuel injection system 100 for shut-down.

Whilst not illustrated, if a circulation main is desirable and used in the fuel injection system, the return from this main should be to the inlet of the low pressure fuel delivery pump(s) 120 and not the service tank 110. This eliminates mixing hot fuel with the cooler fuel in the service tank 110 and reduces the tendency for fuel destabilisation.

It is to be appreciated that the fuel injection system 100 and engine 112 can be used in a variety of applications, including as a stationary power generation engine, and a transportation engine, such as an engine in an ocean going vessel.

For ocean going vessels, the use of carbonaceous slurry fuels can advantageously address sulfur emissions limits for ocean vessels which in many jurisdictions have been restricted to use fuel oil on board with a sulphur content of no more than 0.5%, and in some cases of now more than 0.10%. The sulfur content of carbonaceous slurry fuels, particularly micronized refined carbon fuel (MRC) can be tailored to meet this specific sulfur content restriction. An engine such as disclosed in relation to the present invention, that uses such fuel can therefore assist in meeting these requirements.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A fuel injection system of a diesel type engine configured to use carbonaceous aqueous slurry fuels, the fuel injection system comprising:
at least one fuel injector including an injector nozzle through which fuel is atomised and a fuel injector pump for pressurising fuel for supply to the injector nozzle; and
a controlled bleed valve fluidly connected to each fuel injector and positioned to allow a controlled amount of carbonaceous aqueous slurry fuel to flow from the fuel injector;
wherein the controlled bleed valve comprises at least one of an electronically controlled bleed valve or a hydraulically controlled bleed valve.

2. (canceled)

3. A fuel injection system according to claim 1, wherein the controlled bleed valve is operated to allow flow from the fuel injector after the fuel injection pump draws fuel into the injector and before the fuel injector injects fuel through the injector nozzle.

4. A fuel injection system according to claim 1, wherein the controlled bleed valve is fluidly connected by the injector around or between the fuel injector pump and the injector nozzle.

5. A fuel injection system according claim 1, wherein the injector nozzle includes a flow valve for controlling flow through the injector nozzle and the controlled bleed valve is fluidly connected to the injector at or around said flow valve.

6. A fuel injection system according to claim 1, wherein the flow valve includes a valve seat, and the controlled bleed valve is fluidly connected to the injector at or around the valve seat of the flow valve.

7. A fuel injection system according to claim 1, wherein the flow valve comprises a needle valve.

8. A fuel injection system according to claim 1, wherein the controlled bleed valve is fluidly connected to the fuel injector pump.

9. A fuel injection system according to claim 8, wherein the fuel injector pump comprises a plunger pump including a cylinder and driven plunger for pumping fuel to the injector nozzle and the controlled bleed valve is fluidly connected to a pump volume in the cylinder between the plunger and a fuel inlet of the plunger pump.

10. A fuel injection system according to claim 1, wherein each controlled bleed valve is fluidly connected to a fuel recycle system.

11. A fuel injection system according to claim 10, further including a fuel delivery pump for pumping fuel to the fuel injector, and wherein the fuel recycle stream is fluidly connected between the outlet of the controlled bleed valve and an inlet of the fuel delivery pump.

12. A fuel injection system according to claim 10, further including a fuel circulation main, wherein the return from the fuel circulation main is fluidly connected to the inlet of the fuel delivery pump.

13. A fuel injection system according to claim 10, wherein the fuel recycle stream includes a connection to a waste stream into which flow can be selectively diverted to remove fluid from the fuel recycle stream.

14. (canceled)

15. A fuel injection system according to claim 1, further comprising a service tank into which fresh carbonaceous aqueous slurry fuel is feed, the service tank being fluidly connected to an inlet of the fuel delivery pump.

16-17. (canceled)

18. A fuel injection system according to claim 1, further including a fuel preconditioning system fluidly connected to the inlet of the injector system, the fuel preconditioning system including a fuel preheater for heating the fuel to a service temperature.

19-20. (canceled)

21. A fuel injection system according to claim 1, wherein the flow through the bleed valve is controlled by the flow duty of the bleed valve for a given fuel delivery pressure.

22-23. (canceled)

24. A diesel type engine configured to use carbonaceous aqueous slurry fuels comprising a fuel injection system comprising at least one fuel injector, each injector including:
an injector nozzle through which fuel is atomised and a fuel injector pump for pressurising fuel for supply to the injector nozzle; and
a controlled bleed valve fluidly connected to each fuel injector and positioned to allow a controlled amount of carbonaceous aqueous slurry fuel to flow from the respective injector, wherein the controlled bleed valve comprises at least one of an electronically controlled bleed valve or a hydraulically controlled bleed valve.

25. (canceled)

26. A method for controlling fuel heating and circulation in a diesel type engine using of carbonaceous aqueous slurry fuels, the diesel type engine including a fuel injection system according to claim 1, the fuel injector operating to inject fuel into a combustion chamber of the engine, the method including the steps of:
operating the bleed valve to allow flow from the fuel injector between fuel injection events into the combustion chamber.

27. A method according to claim 26, wherein the controlled bleed valve is operated to allow flow from the fuel injector after the fuel injection pump draws fuel into the injector and before the fuel injector injects fuel through the injector nozzle.

28. (canceled)

29. A method according to claim 26, wherein the flow through the bleed valve is controlled by the flow duty of the bleed valve for a given fuel delivery pressure.

30. A method according to claim 26, wherein each controlled bleed valve is fluidly connected to a fuel recycle system, and during normal engine operation, the fuel recycle stream directs fuel from the bleed valves to the inlet of the fuel delivery pump.

31-36. (canceled)
